(19) United States
(12) Patent Application Publication
(10) Pub. No.: US 2026/0063464 A1
(43) Pub. Date: Mar. 5, 2026

(54) WEIGHING APPARATUS, AUTONOMOUS MATERIAL SYNTHESIS SYSTEM AND METHODS THEREFOR

(71) Applicant: Wisconsin Alumni Research Foundation, Madison, WI (US)

(72) Inventors: Lianyi Chen, Middleton, WI (US); Matthias Beuting, Madison, WI (US)

(21) Appl. No.: 18/823,349

(22) Filed: Sep. 3, 2024

(51) Int. Cl. G01G 19/36; G01G 19/24; G01G 21/22

(52) U.S. Cl. CPC G01G 19/36; G01G 19/24; G01G 21/22

(57) ABSTRACT

Aspects of the disclosure are directed to weighing apparatuses, autonomous materials synthesis systems and methods, as well as their implementation. As may be implemented in accordance with one or more embodiments, a galvanic actuator includes a disk disposed between magnetic poles, and a coil coupled to the disk. A weighing arm is coupled to the disk and includes first and second ends respectively extending away from the disk in opposing directions, the first end having a pan to hold material, the second end having a counterweight. A controller circuit applies voltage to the magnetic poles to generate a magnetic field that applies torque to the disk, countering torque applied to the disk via the material in the pan. Processing circuitry generates an output indicative of weight of the material, based on the voltage applied by the controller circuit for countering the torque.

### BACKGROUND

For many applications, it is desirable to accurately weigh materials to be used in one or more of a variety of manners. For instance, accurate dosing of powder feedstock is important for many industries such as materials synthesis, pharmaceuticals, chemical production, and additive manufacturing.

Achieving sub-milligram resolution and precision is especially challenging in automated processes designed to minimize human intervention. Such approaches may be useful, for example, for processing powders that cannot be handled in standard atmosphere. For instance, samples for materials synthesis applications may be desirably prepared by fusing metal powders mixed under vacuum. Such conditions pose challenges for achieving an accurate, automated weighing scheme for a variety of applications. As such, fabricating bulk materials at high throughput is challenging. Variations in composition of produced materials due to imprecise dosing or impurities introduced by manual handling can significantly alter its microstructure and properties, and may result in a high rate of defects such as porosity.

These and other matters have presented challenges to material supply and implementation, for a variety of applications.

### SUMMARY

Various example embodiments are directed to material weighing processes and apparatuses, their application and their manufacture. Such embodiments may be useful for controlling material supply in applications benefitting from a high level of accuracy. Further, many such embodiments are useful for addressing challenges as characterized above, such as with environments requiring a vacuum or other sanitary-type characteristics.

As may be implemented in accordance with one or more embodiments, an apparatus comprises a galvanic actuator, a weighing arm, a controller circuit and processing circuitry. The galvanic actuator includes a disk disposed between opposing magnetic poles that generate a magnetic field, and a coil coupled to the disk. The weighing arm is coupled to rotate with the disk, and has first and second ends respectively extending away from the disk in opposing directions, the first end having a pan to hold material, the second end having a counterweight. The controller circuit is configured to apply voltage to the opposing magnetic poles to generate a magnetic field that applies torque to the disk that counters torque applied to the disk via the material in the pan. The processing circuitry is configured to generate an output indicative of weight of the material, based on an amount of voltage applied by the controller circuit for countering the torque applied to the disk via the material held in the pan.

Another embodiment is directed to an apparatus comprising a plurality of dosing stations and a sample holder to hold a plurality of coupons. Each coupon is configured to hold material, and to rotate the coupons to respective ones of the dosing stations for receiving respective types of material from each dosing station. Each dosing station has an electrobalance including a galvanic actuator, a weighing arm, a controller circuit and processing circuitry. The galvanic actuator includes a disk disposed between opposing magnetic poles that generate a magnetic field, and including a coil coupled to the disk. The weighing arm is coupled to rotate with the disk, and has first and second ends respectively extending away from the disk in opposing directions, the first end having a pan to hold material and the second end having a counterweight. The controller circuit is configured to apply voltage to the opposing magnetic poles to generate a magnetic field that applies torque to the disk that counters torque applied to the disk via the material in the pan. The controller circuit is further configured to adjust the applied voltage to cause the weighing arm to dispense the material out of the pan and onto one of the coupons. The processing circuitry is configured to generate an output indicative of weight of the material, based on an amount of voltage applied by the controller circuit for countering the torque applied to the disk via the material held in the pan. The apparatus further includes an energy source configured to melt the material in each coupon.

Another embodiment is directed to a method carried out as follows. An electrobalance is provided, and includes a galvanic actuator, a weighing arm, a controller circuit and processing circuitry. The galvanic actuator includes a disk disposed between opposing magnetic poles that generate a magnetic field, and including a coil coupled to the disk. The weighing arm is coupled to rotate with the disk and has first and second ends respectively extending away from the disk in opposing directions, the first end having a pan to hold material and the second end having a counterweight. The controller circuit is configured for applying a voltage to the opposing magnetic poles to generate a magnetic field that applies torque to the disk and counters torque applied to the disk via the material in the pan. The processing circuitry is configured to generate an output indicative of weight of the material, based on an amount of voltage applied by the controller circuit for countering the torque applied to the disk via the material held in the pan. While feeding material into the pan, the controller circuit is utilized to adjust the applied voltage to the opposing magnetic poles to maintain the weighing arm in a fixed position. Using the processing circuitry, the output indicative of the weight of the material is generated, therein terminating the feeding of material in the pan in response to the weight achieving a target weight.

The above discussion/summary is not intended to describe each embodiment or every implementation of the present disclosure. The figures and detailed description that follow exemplify various embodiments.

### BRIEF DESCRIPTION OF FIGURES

Various example embodiments may be more completely understood in consideration of the following detailed description and in connection with the accompanying drawings, in which:

FIG. 1A and FIG. 1B show a weighing apparatus as may be implemented in accordance with one or more embodiments, in which:

FIG. 1A shows the apparatus in a balanced state for weighing, and

FIG. 1B shows the apparatus in a dispensing state for dispensing weighed materials;

FIG. 2A and FIG. 2B show an autonomous material synthesis apparatus including a chamber for preparing samples, in which FIG. 2A shows an overview of the apparatus and FIG. 2B shows an enlarged view of the interior of the chamber, in accordance with various embodiments;

FIG. 3 shows a flow diagram for preparing samples, as may be implemented in accordance with one or more embodiments; and

FIGS. 4A-4C show an apparatus and approach to powder deposition manufacturing, as may be implemented in accordance with one or more embodiments, and in which:

FIG. 4A shows a material feeder, a weighing component and a sample cup;

FIG. 4B shows the components in FIG. 4A with the weighing component dispensing powder into the sample cup; and

FIG. 4C shows the sample cup with an electroplaning electrode for manipulating the powder for the formation of a layer in the sample cup.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving one or more of powder/material delivery, weighing, and additive manufacturing. In certain implementations, aspects of the present disclosure have been shown to be beneficial when used in the context of controlling powder delivery with a high level of accuracy, for use with additive manufacturing processes. While not necessarily so limited, various aspects may be appreciated through a discussion of examples using such exemplary contexts.

According to various example embodiments, an apparatus includes a galvanometer with a weighing arm/lever and a material holding pan. The galvanometer acts as an electrobalance in conjunction with a closed-loop controller that is used to adjust voltage applied thereto, in order to keep the galvanometer level when a sample is added to the weighing pan. The necessary voltage applied depends on the sample weight, for achieving balance. Using this approach, it has been recognized/discovered that microgram precision can be achieved in a variety of implementations. As such, various applications involving pharmaceuticals, chemicals, material science, and additive manufacturing may be facilitated.

The galvanometer may also be used as an actuator to remove material such as powder from the weighing pan after the measurement, thus enabling automatic measuring. To accomplish this, the controller temporarily disables the control loop and instead applies a voltage that causes the lever to move downward, dropping the powder. The scale then levels and zeros itself again to prepare for a new measurement. This allows either automated dosing in rapid succession or periodic sampling of a powder stream without human interaction.

In various embodiments, the galvanometer and arm/weighing pan is implemented as a single moving part that can be utilized for both measurement and dispensing. Such an approach provides an exceptionally compact design. In certain implementations, low outgassing components are utilized such that the apparatus can be used in vacuum chambers.

Particular embodiments are directed to additive manufacturing processes, such metal 3D printing in which metal powders are melted and solidified in a layer-by-layer process. Precise doses of different materials can be accurately provided using the measuring approaches characterized herein. This can facilitate the formation of individual layers and/or individual samples having differing properties, such as to modify the composition of alloys between layers. This enables creating compositionally graded materials, which can be leveraged to produce printed parts with surfaces that are resistant to wear or corrosion. Such approaches may be utilized in materials synthesis systems for autonomous materials discovery, involving the rapid formation of a multitude of samples having disparate compositions and/or properties.

Certain embodiments are directed to Autonomous Materials Discovery and Manufacturing (AMDM) approaches involving the development of new materials with varied compositions and/or properties, utilizing a weighing apparatus/approach as characterized herein. Tens, hundreds or thousands of material samples may be generated rapidly and with different compositions. Neural networks may be trained with the results and used to predict desirable or optimal material compositions for a specific purpose. When implemented with additive manufacturing approaches, bulk metal samples of varied composition can be manufactured at a high throughput, and while addressing quality type issues as characterized herein.

Another particular embodiment is directed to an Autonomous Material Synthesis System (AMSS) system and/or approach that can produce a large number of metal alloy samples with varying compositions. This may be carried out in a short time and, if desired, without user interaction. The system may utilize Powder Bed Fusion (PBF) technology for additive manufacturing, producing parts of varied shapes by selectively melting metal powders using focused laser beam. The system varies the material composition by mixing different metal powders in different ratios. Using PBF, samples may be produced in a shape that can be used directly for mechanical testing. The system facilitates control of the sample composition with high precision (e.g., material composition uncertainty less than 0.5%). In addition, the samples can be produced at high quality, with near-zero porosity and other defects in the material microstructure. Processing conditions may be optimized for additive manufacturing, for each composition.

Powder materials may be mixed in a variety of manners. In certain embodiments, powders are mixed after deposition, for example by utilizing electrostatic forces. This may address challenges to pre-mixing, as differences in particle size may lead to segregation of the powder during charging due to granular convection (Brazil nut effect), or because of a significant difference density for example when using refractory alloy elements. Further, powder redistribution during the melting process can be mitigated or eliminated, for providing desirable composition control.

Various aspects of the present disclosure are directed to systems and methods that implement trained artificial intelligence (AI) and/or machine learning (ML) processing to facilitate the selection of compositions, deposition conditions, melting conditions and more. These approaches may be carried out relative to the formation of a multitude of samples, utilizing one or more of the weighing and/or dispensing schemes characterized herein. For instance, trained AI processing. Analysis of compositions may involve identifying correlations between different compositions and resulting properties, as may relate to strength, conductivity, weight, resiliency, and more.

In certain embodiments, one or more AI models are utilized to enhance the processing of materials and the formation of samples as described herein. Trained AI processing may be utilized to aid determinative or predictive processing including specific processing operations described with respect to the selection of materials, shape and/or sizes for samples, ranking and/or scoring of samples, and the prediction of properties for proposed sample compositions.

Various implementations involve the creation, training, application, and updating of AI modeling. Trained AI processing may be adapted to execute specific determinations described herein including those for selecting sample composition and the ensuing creation of samples. For instance, an AI model may be specifically trained and adapted for execution of processing operations pertaining to analyzing characteristics of as-built samples. Exemplary AI processing may be applicable to aid determinative or predictive processing using aspects of the present disclosure, as may relate to learning for selecting composition, shape or size of structures to be formed.

In one example, a hybrid AI model (e.g., hybrid machine learning model) is adapted and trained to execute a plurality of processing operations described in the present disclosure, such as may relate to the control and implementation of weighing and dispensing schemes for the formation of structures. In alternative examples, trained AI processing comprises a collective application of a plurality of AI models that are separately trained and managed to execute processing described herein. In alternative examples, the present disclosure extends to integrating third-party AI modeling and further adapting and customizing said AI modeling to work with specific data and data sources of an exemplary software platform. For example, a third-party AI model may be adapted to assess as-built parts and/or to control dispensing systems as characterized herein for forming parts with multiple different types of materials.

Various supervised learning approaches may be utilized, and may include one or more of: nearest neighbor processing; naive bayes classification processing; decision trees; linear regression; support vector machines (SVM) neural networks (e.g., convolutional neural network (CNN) or recurrent neural network (RNN)); and transformers, among other examples. Example unsupervised learning approaches that may be applied to approaches herein may include one or more of: application of clustering processing including k-means for clustering problems, hierarchical clustering, mixture modeling, etc.; application of association rule learning; application of latent variable modeling; anomaly detection; and neural network processing, among other examples. Example semi-supervised learning approaches may include one or more of assumption determination processing; generative modeling; low-density separation processing and graph-based method processing, among other examples. Example reinforcement learning approaches may include one or more of value-based processing; policy-based processing; and model-based processing, among other examples. Furthermore, a component for implementation of trained AI processing may be configured to apply a ranker to generate relevance scoring to assist with any processing determinations with respect to any relevance analysis, such as that relating to the relevance of certain material property characteristics or other aspects as described herein. Scoring for relevance (or importance) ranking may be based on individual relevance scoring metrics or an aggregation of said scoring metrics. In some examples where multiple relevance scoring metrics are utilized, a weighting may be applied that prioritizes one relevance scoring metric over another depending on the type of data being collected, such as by prioritizing certain material properties over others to emphasize a particular need for an end product. Results of a relevance analysis may be finalized in a variety of manners, such as by utilizing a threshold analysis of results, where a threshold relevance score may be comparatively evaluated with one or more relevance scoring metrics generated from application of trained AI processing.

In certain embodiments, a process control system utilized for sample formation autonomously finds processing parameters that correspond to a stable keyhole regime. A high-speed camera may be used to image the melt pool around the process beam. Real-time image processing then extracts the total intensity of the light emitted by the melt pool, which oscillates at a constant frequency under stable keyhole conditions. Wavelet analysis is used to calculate spectrograms from this time trace. A machine learning algorithm then distinguishes between spectrograms corresponding to stable and unstable keyhole conditions. Such approaches maybe used with powder bed fusion, in which the complex interaction between the liquid melt pool, the vaporized metal plume and the process laser leads to the formation of a tapered vapor cavity, the so-called keyhole. Processing parameters may be chosen so that a stable keyhole is formed, for instance by providing sufficient laser powder for forming the keyhole while avoiding laser power that is too high and that would render the keyhole unstable (and which may lead to porosity). If the laser power is too low, no keyhole is formed leaving incompletely melted powder particles behind. To find a desirable combination of power and scan speed, the process control system may vary the beam power from high to low until stable keyhole oscillations are detected when starting to process the first layer. The power is then adjusted to a little less (e.g., 90%) for the rest of the processing to ensure processing under stable keyhole conditions.

Certain aspects of the disclosure are directed to an apparatus comprising a galvanic actuator, a weighing arm, a controller circuit and processing circuitry. The galvanic actuator includes a disk disposed between opposing magnetic poles that generate a magnetic field, and a coil coupled to the disk. The disk may have a variety of shapes, including non-round shapes, or may be replaced by another shape, have varied thickness or surface structure. The weighing arm is coupled to rotate with the disk, and has first and second ends respectively extending away from the disk in opposing directions. The first end has a pan to hold material, and the second end has a counterweight. The controller circuit applies voltage to the opposing magnetic poles to generate a magnetic field that applies torque to the disk that counters torque applied to the disk via the material in the pan. The processing circuitry generates an output indicative of weight of the material, based on an amount of voltage applied by the controller circuit for countering the torque applied to the disk via the material held in the pan. In some instances, the processing circuitry outputs the weight of the material by correlating the amount of voltage supplied by the controller to the torque applied by the material, and by calculating the weight based on the torque and characteristics of the weighing arm.

The apparatus may include a sensor circuit to sense the position of the weighing arm and to provide an output to the controller circuit indicative of the sensed position. In such instances, the controller circuit may apply the voltage to the magnetic poles in response to the sensed position. Further, the galvanic actuator and weighing arm may operate to maintain the weighing arm in an unweighted position when the pan is devoid of the material, in which instance the controller circuit may apply voltage to the magnetic poles that applies the torque to the weighing arm in order to position the weighing arm in the unweighted position, in response to the material being placed in the pan.

In some instances, the apparatus further includes a material feed channel to dispense the material onto the pan. Such a feed channel may, for example, utilize a pipe-type material that conveys powder, and one or more characteristics that facilitate conveyance of the powder. The material feed channel may be configured to control an amount of the material that is dispensed onto the pan based on the output indicative of the weight of the material.

In certain embodiments, after the output indicative of the weight of the material is generated, the controller adjusts the applied voltage to cause the weighing arm to rotate for dispensing the material out of the pan. The apparatus may include a sample holder to receive the material dispensed from the pan, and an electrode to mix the powder in the sample holder.

Another embodiment is directed to an apparatus including a plurality of dosing stations and a sample holder to hold a plurality of coupons, each coupon holding material, and the sample holder rotates the coupons to respective ones of the dosing stations for receiving respective types of material from each dosing station. Each dosing station has an electrobalance including a galvanic actuator, a weighing arm, a controller circuit and processing circuitry. The galvanic actuator includes a disk disposed between opposing magnetic poles that generate a magnetic field, and including a coil coupled to the disk. The weighing arm is coupled to rotate with the disk, and has first and second ends respectively extending away from the disk in opposing directions. The first end has a pan to hold material and the second end has a counterweight. The controller circuit applies voltage to the opposing magnetic poles to generate a magnetic field that applies torque to the disk, which counters torque applied to the disk via the material in the pan. The controller circuit adjusts the applied voltage to cause the weighing arm to dispense the material out of the pan and onto one of the coupons. The processing circuitry is configured to generate an output indicative of weight of the material, based on an amount of voltage applied by the controller circuit for countering the torque applied to the disk via the material held in the pan. The apparatus also includes an energy source, such as a laser or electron beam, to melt the material in each coupon. An electroplaning electrode may be utilized to apply a voltage to the coupons for electrostatically mixing powder in the coupons. Further, one or more of the dosing stations may provide a type of material for the coupons that is different than a type of material provided by another one of the dosing stations.

Using such an apparatus, automatic powder delivery can be utilized to provide continuous or nearly continuous powder delivery to respective coupons with different compositions/amounts of material in a rapid fashion, which may facilitate rapid prototyping. For instance, powder bed fusion may be carried out to fabricate a materials library of samples.

In-situ powder mixing may be implemented on a powder bed to facilitate the mixing and/or leveling of deposited powder, prior to melting. For instance, one or more of electrical fields, vibration, and stirring (e.g., mechanical mixing) may be utilized for mixing.

Further, such approaches may be utilized for on-the-fly processing parameter identification and optimization. For instance, one or more of high speed in-situ monitoring, high speed parameter prediction (as may implement an AI/machine learning algorithm), and high speed processing parameter tuning. The parameter tuning may be utilized for controlling a laser, electron beam or other heat source in intensity/power, and/or in application speed and approach. During the manufacturing process, aspects thereof can be observed and changes can be made, or a test may be run, without stopping the system.

In certain implementations, the sample holder, dosing stations, electrode and energy source generate multi-layer samples having disparate compositions of material as provided by respective ones of the dosing stations as follows. Materials are weighed and dispensed from the respective dosing stations onto the coupons to form a first layer, the first layer is agitated, melted, then solidified. After the first layer is solidified, materials are weighted and dispensed from the respective dosing stations onto the coupons to form a second layer on the first layer. The second layer is then agitated, melted, and solidified to form respective layers of material on each coupon. The second layer may, for at least one of the coupons, include a composition that is different than a composition of the first layer.

The apparatus may include a variety of components such as those characterized herein. For instance, the apparatus may include an electrode to agitate the material in each coupon via application of electrostatic force to the material. In such instances, the sample holder may be configured to align each coupon to the electrode. A camera may be included to image the coupons relative to the energy source melting material in each coupon.

Processing circuitry may be utilized to process image data captured by the camera to assess characteristics of the material in each coupon, and to generate an output indicative of a change in processing conditions for forming the samples in each coupon. The processing conditions may include conditions selected from the group of: sample composition, energy source application, and a combination thereof. In certain instances, the processing circuitry may utilize an AI/ML algorithm to assess the characteristics of the material and generate the output, and may communicate the output to the dosing stations and the energy source for in-situ adjustment of the processing parameters.

Another embodiment is directed to a method carried out as follows. An electrobalance is provided, and includes a galvanic actuator, a weighing arm, a controller circuit and processing circuitry. The galvanic actuator includes a disk disposed between opposing magnetic poles that generate a magnetic field, and a coil is coupled to the disk. The weighing arm is coupled to rotate with the disk and has first and second ends respectively extending away from the disk in opposing directions. The first end has a pan to hold material and the second end has a counterweight. The controller circuit is used to apply a voltage to the opposing magnetic poles to generate a magnetic field that applies torque to the disk and counters torque applied to the disk via the material in the pan. The processing circuitry generates an output indicative of weight of the material, based on an amount of voltage applied by the controller circuit for countering the torque applied to the disk via the material held in the pan. While feeding material into the pan, the controller circuit is utilized to adjust the applied voltage to the opposing magnetic poles to maintain the weighing arm in a fixed position. Using the processing circuitry, the output indicative of the weight of the material is generated, therein terminating the feeding of material in the pan in response to the weight achieving a target weight.

A sample holder may be utilized to hold a plurality of coupons, selectively align each coupon with the electrobalance, and the weighing arm may be actuated for dispensing material from the pan into the coupon. One of such electrobalances may be provided for each of a plurality of dosing stations. Multi-layer samples are generated with disparate compositions of material as provided by respective ones of the dosing stations, by weighing and dispensing materials from the respective dosing stations onto the coupons to form a first layer. This first layer formation includes moving the sample holder to position the coupons relative to the dosing stations, agitating the first layer, melting the first layer, and solidifying the first layer. After the first layer is solidified, materials are weighed and dispensed from the respective dosing stations onto the coupons to form a second layer on the first layer. The second layer is agitated, melted and solidified to form respective layers of material on each coupon.

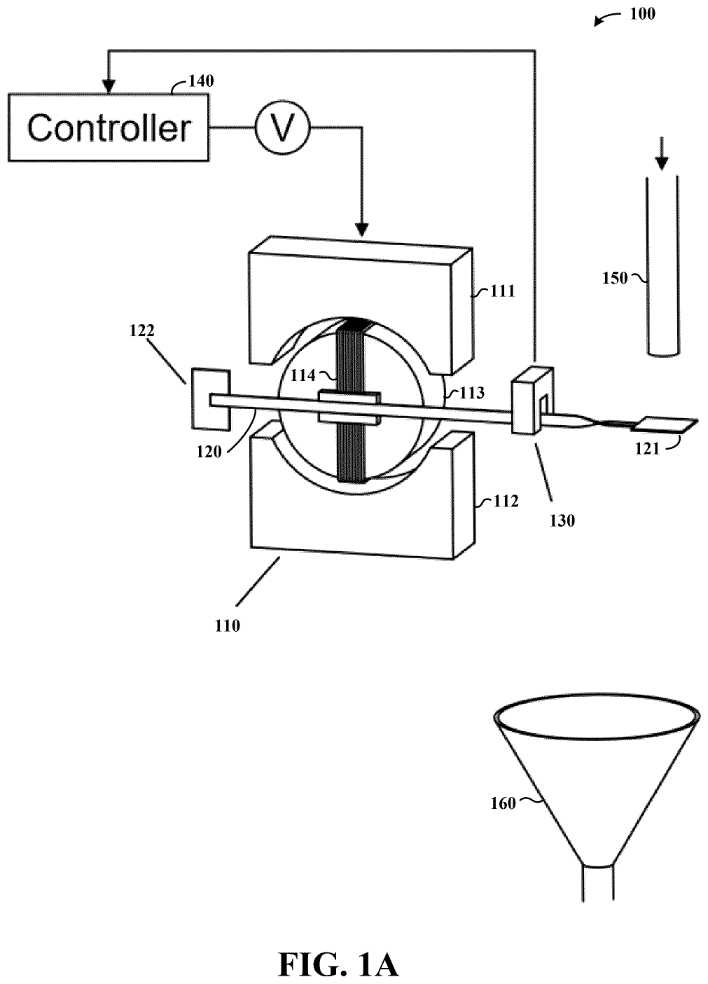

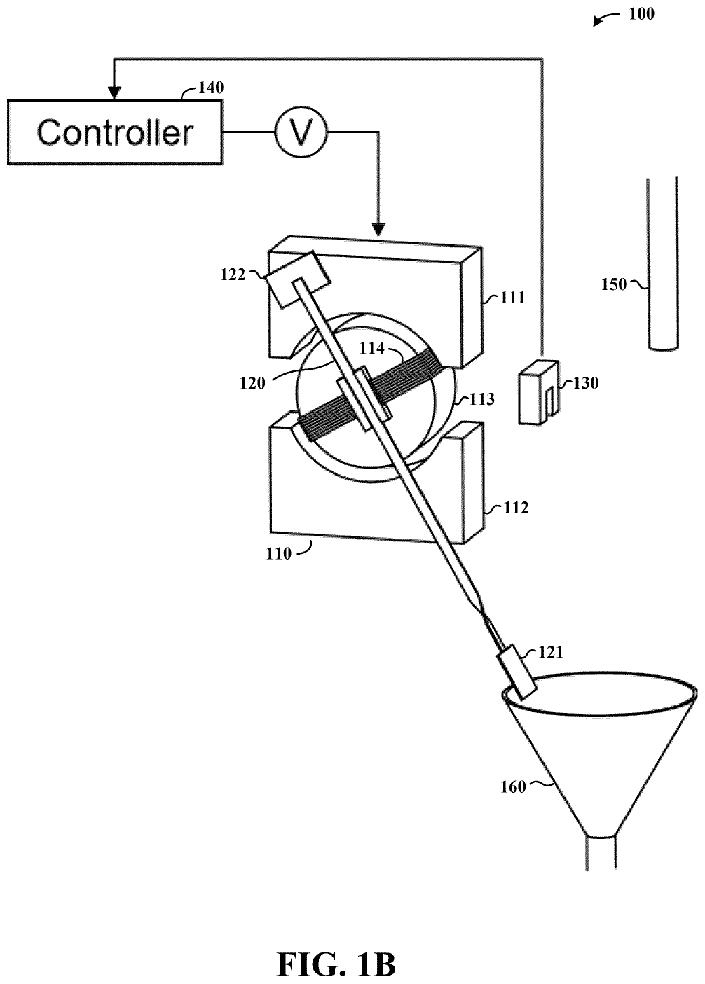

Turning now to the Figures, FIG. 1A and FIG. 1B show a weighing apparatus 100, as may be implemented in accordance with one or more embodiments. FIG. 1A shows the apparatus 100 in a balanced state for weighing, and FIG. 1B shows the apparatus in a dispensing state for dispensing weighed materials, as may be implemented for high-precision autonomous powder dosing. The apparatus 100 includes a galvanometer 110 having upper and lower electrodes 111 and 112, as well as a rotatable cylinder 113 having an inductive coil 114. A lever 120 is coupled to rotate with the cylinder 113, and has a weighing pan 121 at one end and a counterweight 122 at the other end. A photoelectric sensor 130 senses the position of the lever 120, and a controller 140 applies a voltage to the galvanometer 110 for adjusting the position of the lever. A material supply 150 supplies material for collection in the weighing pan 121, and a collection receptacle 160 operates to receive weighed material when dispensed.

Referring to FIG. 1A, the lever 120 is held in the horizontal position, using a closed control loop including the photoelectric sensor 130 and controller 140, which keep the weighing pan 121 level by monitoring its position with a photoelectric sensor and adjusting the voltage on the galvanometer 110. The voltage depends on the mass placed in the weighing pan, which facilitates weight measurement with microgram accuracy. After the measurement, the powder may be dispensed from the weighing pan to the collection receptacle 160 (e.g., and to a sample matrix), by modulating the voltage of the galvanometer 110, as shown in FIG. 1B. This approach can be utilized to achieve an accuracy of 100 μg or less, at a measuring range of 70 mg, which may be useful in mixing high entropy alloys (e.g., 100 to 300 mg per layer required).

The apparatus 100 may be utilized for a variety of applications. For instance, while various embodiments are characterized in the context of additive manufacturing, a myriad of disparate types of materials may be weighed and dispensed. For instance, certain embodiments are directed to pharmaceutical applications in which pharmaceutical materials are automatically weighed with high accuracy. Such an approach may involve the formation of medicines requiring accurate dosage.

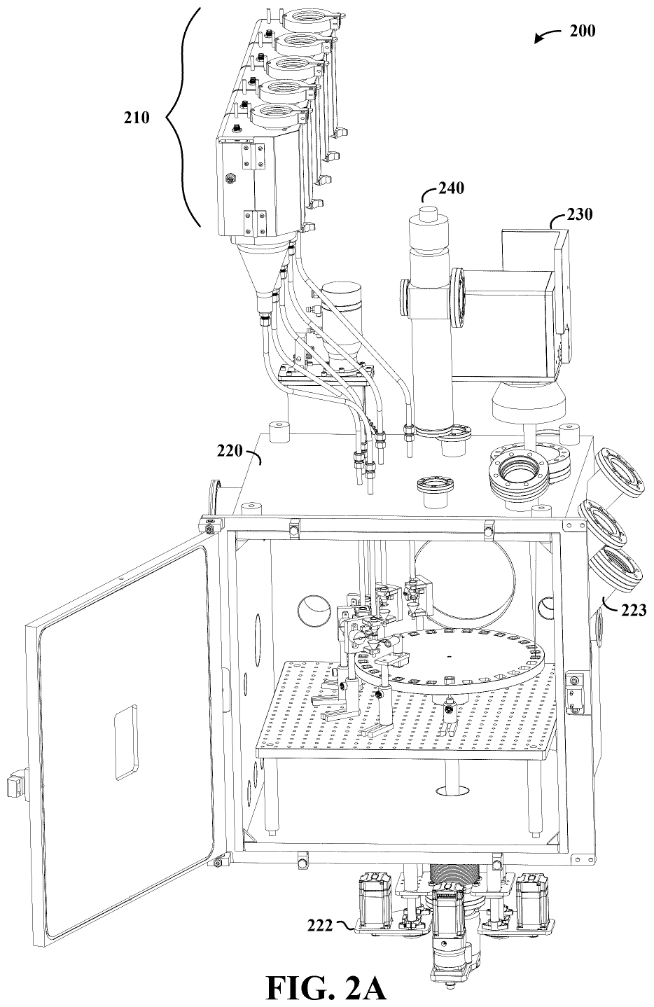

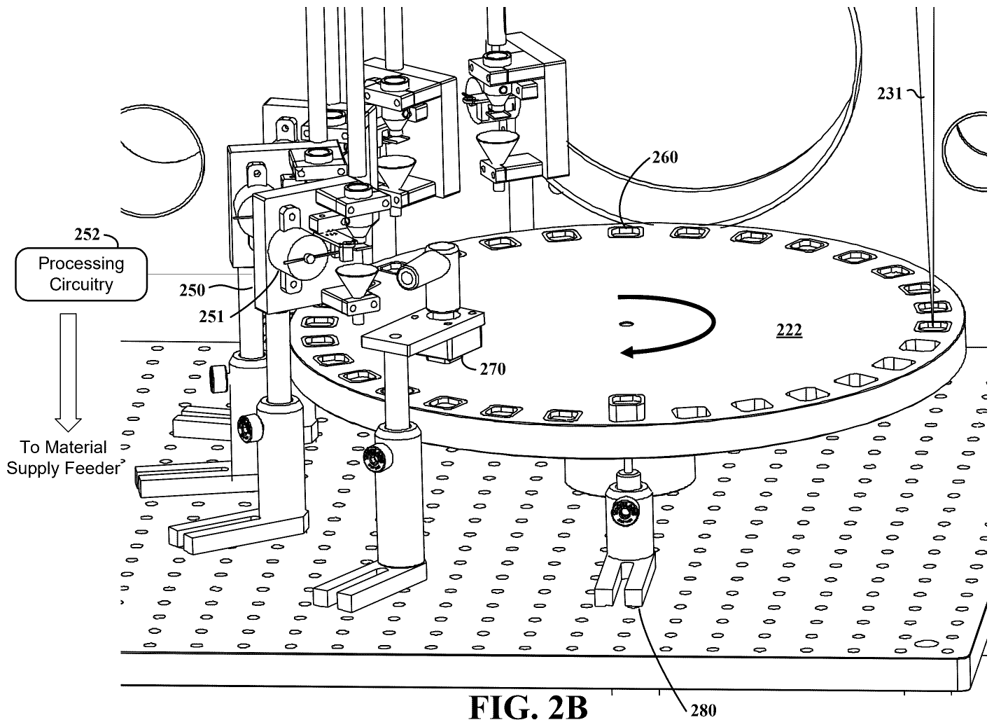

FIGS. 2A and 2B show an apparatus 200 for preparing samples, as may be implemented in accordance with various embodiments. The apparatus 200 includes multiple material supply feeders 210, which may include hopper-type feeders that each provide a different type of powder. A chamber 220, shown in greater detail in FIG. 2B, houses a rotating platform 221 for holding samples and driven by a motion stage 222 that may rotate and raise/lower the platform 221. The chamber also includes multiple weighing apparatuses that may utilize the apparatus shown in FIGS. 1A and 1B, to dispense materials for rapidly forming multiple samples.

Referring to FIG. 2B, five weighing apparatuses are shown, with apparatus 250 labeled and including a galvanometer 251. Each of the weighing apparatuses is aligned to receive material from one of the material supply feeders 210. The platform 221 holds multiple coupons, including coupon 260, for holding powder. The coupons may be rotated via the platform 221 and motion stage 222 to respective positions that align with the weighing apparatuses 210 for receiving material therefrom. For example, a coupon could be aligned to receive a single type of powder from a single weighing apparatus, or to two respective ones of the weighing apparatuses in succession to receive two or more types of powder.

An electroplaning electrode 270 operates to mix and flatten the powder in each coupon as the coupon is aligned thereto, by agitating the powder with electrostatic forces. One or more energy sources may be used to melt the powder in the coupons, such as process laser 230 that produces beam 231, and/or an electron gun 240. A sample ejection component 280 operates to eject the coupons upon completion, for example by lowering the disk onto a pin aligned with a hole at the bottom of the sample holder to push the coupons upward and out of the platform 221.

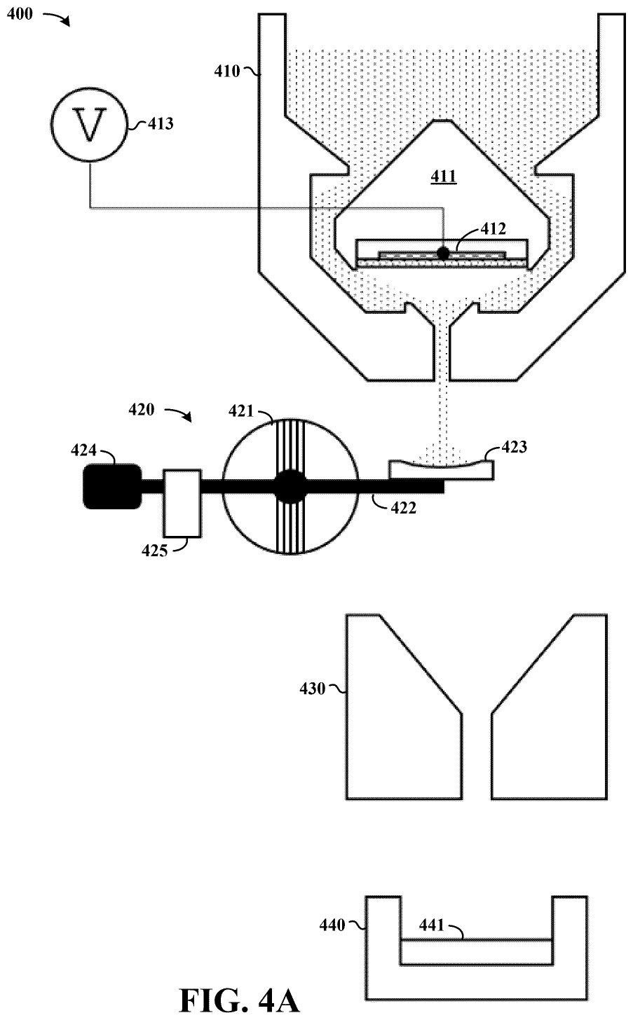

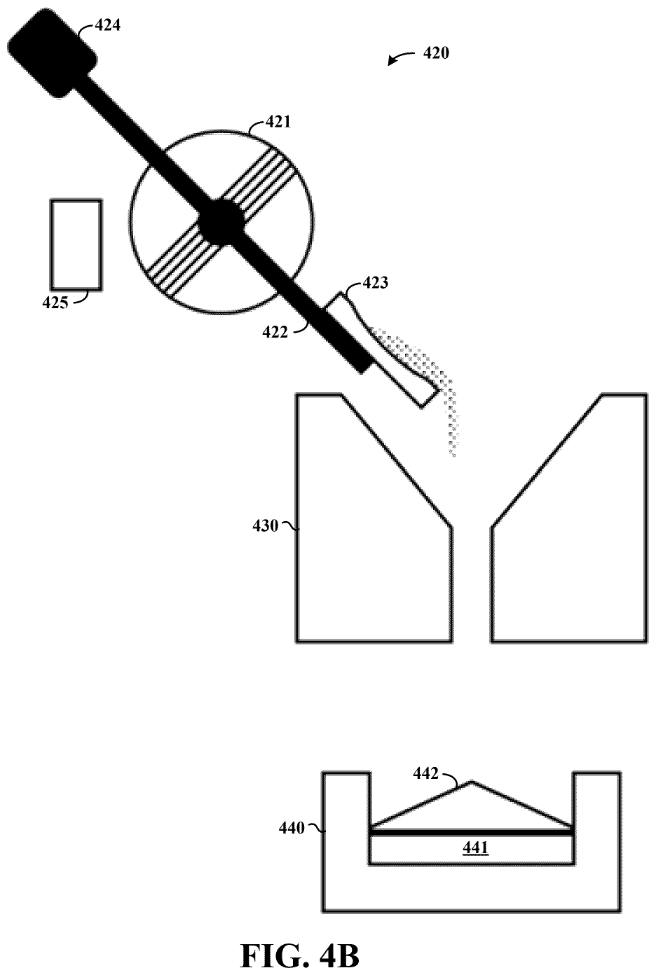

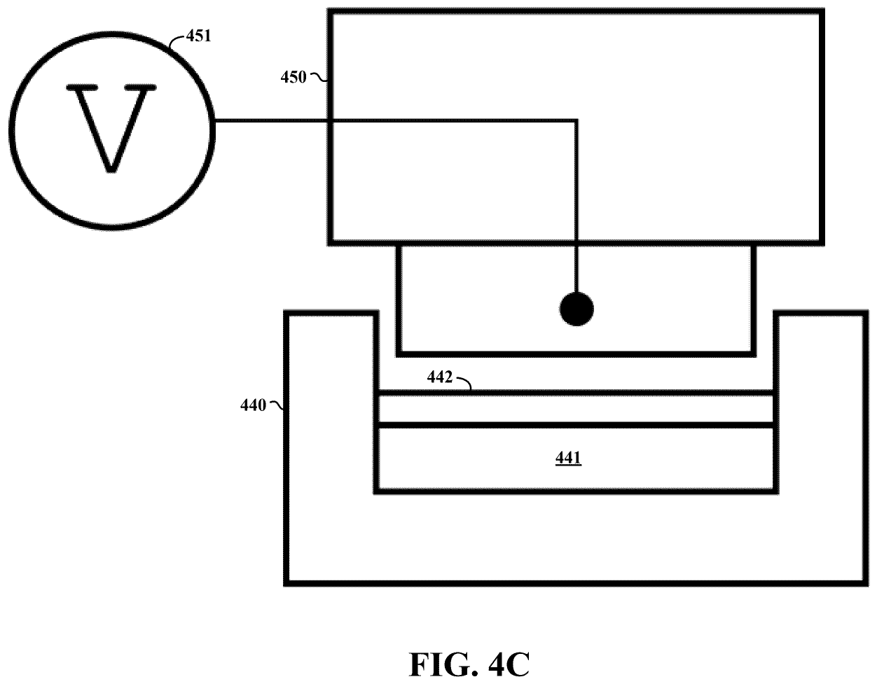

Processing circuitry 252 may be utilized to generate an output indicative of an amount of voltage applied to the galvanometer 251, which provides an indication of the weight of powder supplied to the weighing apparatus. This output can be provided to the corresponding material supply feeder that feeds powder to the weighing apparatus, to control the amount of powder being supplied. Such an approach may be implemented with an apparatus as shown in FIG. 4A and discussed below, and further used to control the application of voltage to electrode 412.

The energy sources may be steered and focused using galvo mirrors and an F-theta lens or magnetic lenses, respectively. The beam power, size, shape, focus, scanning speed can be adjusted at a high frequency. This facilitates fast preheating and sintering of the powder by increasing the spot size, and allows optimizing the beam power and scan speed for new material compositions. Preheating extends the range of materials to include refractory alloys that need to be processed at higher temperatures, while pre-sintering powder particles in place prevents cross-contamination from airborne powder particles (spatter). To further reduce contamination from condensed metal vapor deposition, a shielding gas flow may be directed horizontally across the powder bed, blowing off fumes emitted from the melt pool. This flow may be shaped using various nozzles to reduce the flow velocity near the bed surface to prevent turbulence from disturbing the powder.

The apparatus 200 may include a viewing port 223, for assessing the formation of materials within the chamber 220. For instance, a camera may be utilized along with machine vision software to assess characteristics of samples formed in the coupons, with real-time feedback provided and utilized for adjusting one or more aspects of the sample formation. Such aspects may involve adjusting the quantity and composition of powders suppled to each sample, utilizing the material supply feeders 210. Further, the laser 230 and/or electron beam gun 240 may be adjusted from a processing perspective, for example by adjusting power, size, shape, focus, scanning speed and/or pulse timing (where applicable).

In one implementation, the coupons 260 are first filled with a defined quantity of powder from one or more of the material supply feeders 210 arranged around the platform 220, each of which supplies a component of a target alloy. The powder is then mixed and flattened by moving the coupons past the electroplaning electrode 270, which agitates the powder with electrostatic forces (electroplaning). The platform 220 is then rotated by the motion stage 222 to expose each coupon to the field of view of a process beam (laser or electron beam), which melts and solidifies the powder layer. A high-speed camera monitors the melting process via viewing port 223 in order to adjust the processing parameters on the fly. A new layer of powder is then applied and the process may be repeated (e.g., until the pocket in each coupon is completely filled). The process may be carried out in a high vacuum chamber to remove trace gases that may otherwise contaminate the samples. The actual processing can then take place under precisely controlled gas compositions or even in a vacuum to facilitate the use of electron beams. Finally, the produced samples are ejected and can be placed on a holder for testing.

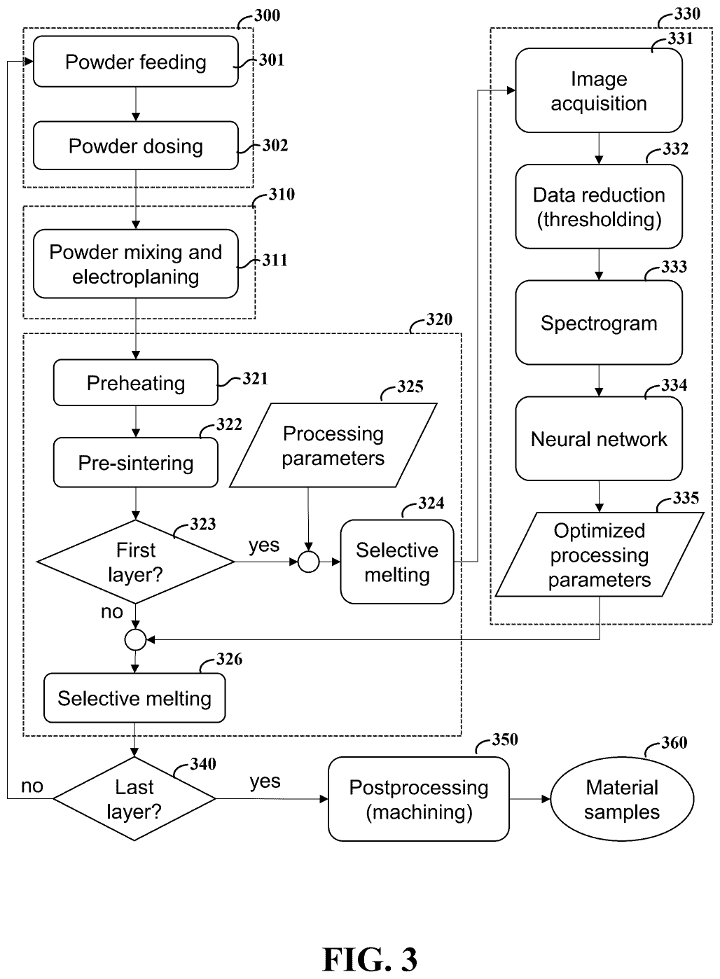

FIG. 3 shows a flow diagram for preparing samples, as may be implemented in accordance with one or more embodiments. At block 301, powder feeding is carried out for use in filling samples, and the powder is dosed at block 302 for forming the samples with a precise amount of powder. These steps may be carried out in a high precision powder delivery system as shown by dashed lines 300, such as that shown in FIG. 1A (feeding) and FIG. 1B (dispensing). At block 311, powder mixing and electroplaning is carried out. This may involve using a mixing and planing system 310, such as characterized in FIG. 2B and in FIG. 4C as discussed below.

The ensuing steps involve forming samples and may be carried out in a processing system 320, such as that depicted in FIG. 2A. At block 321, the mixed and planed powder samples are preheated, followed by pre-sintering at block 322. If the powder is not the first layer of the sample at 323, selective melting is carried out at block 326. If the layer being formed is not the last layer at 340, the process continues at block 301 (or possibly at block 302 if sufficient material has already been supplied), to provide further powder dosing followed by additional melting steps. If the layer being formed is the last layer, post processing/machining steps may be carried out at block 350 and material samples may be output at block 360.

If the powder is a first layer at 323, selective melting is carried out at block 324 using processing parameters 325 as inputs. The material is then optionally assessed, which may be carried out by a process control system 330. At block 331, image acquisition is carried out to obtain one or more images of the sample. The acquired image data is then thresholded at block 332, a spectrogram is created at block 333 and the data is processed in a neural network at block 334 for generating optimized processing parameters 335. These parameters may then be used as parameters for processing subsequent layers. The process may then continue at block 326 with selective melting or, if additional melting is not needed, the process may continue at block 340.

Of note, while the above-discussed flow characterizes an optional assessment after the first layer is formed, this assessment may be omitted and the process may simply follow the selective melting step at 326, which may in turn be followed by the deposition of additional layers. Furthermore, the optional assessment may be carried out on layers formed subsequently to the first layer. This process may be carried out on a multitude of samples, iteratively assessing various compositions and schemes for making the samples, providing an automated manner in which to rapidly develop materials for particular applications. In addition to cameras, other sensors such as an acoustic sensor, chemical composition sensor, and pressure sensor, can be used to monitor the samples and processing processes, and may further provide inputs for machine learning algorithms. These various sensors (and the camera) may be used alone or in combination with one another.

FIGS. 4A-4C show an apparatus 400 and approach to powder deposition manufacturing, as may be implemented in accordance with one or more embodiments. FIG. 4A shows a cross-sectional view of a material supply including an electrodynamic feeder having a housing 410 and central portion 411 with an electrode 412 therein. The electrode is coupled to a voltage controller 413, which applies a voltage to apply an oscillating field. This field controls the flow of material through the housing as to be utilized in adding material to a sample cup 440, which is shown having a first layer 441 already formed therein.

A weighing component 420 includes a galvanic actuator 421 to which a weighing arm 422 is coupled, and which has a weighing pan 423 and a counterbalance 424 on opposing ends. A position sensor 425 senses the position of the weighing arm 422 for weighing (e.g., assessing an amount of voltage/torque applied to counter material placed in the pan), and for dispensing. These components may be implemented using the apparatus 100 shown in FIG. 1A.

Referring to FIG. 4B, the weighing arm 422 has been actuated via the galvanic actuator 421, dispensing powder through a funnel 430 and into the sample cup 440. This material is depicted as material 442 placed onto layer 441. The sample cup 440 may then be placed relative to an electroplaning electrode 450 as shown in FIG. 4C, such as by rotating the sample cup on a platform in a manner as depicted in FIG. 2B. The electroplaning electrode 450 has applied electrostatic forces using a voltage supply 451, to mix and level the material 442 into a flat layer as shown in the figure. From here, laser or other energy can be applied to melt the material 442.

Based upon the above discussion and illustrations, those skilled in the art will readily recognize that various modifications and changes may be made to the various embodiments without strictly following the exemplary embodiments and applications illustrated and described herein. For example, additional analysis steps may be carried out for various layers of samples being made. Fewer or more powder supplies may be utilized and larger or smaller sets of coupons or samples may be utilized. Components referred to as a cylinder or disk may have differing shapes, such as irregular surfaces or non-cylindrical shapes, or be replaced by components with different shapes. Various analysis methods may be implemented to assess conditions, such as by tensile testing the as-built samples. Further, some approaches involve building parts that mimic shapes of a target part, such that aspects of various manufacturing approaches may be assessed in the context of the mimicked shapes. Such modifications do not depart from the true spirit and scope of various aspects of the invention, including aspects set forth in the claims.

What is claimed is:

1. An apparatus comprising:
a galvanic actuator including a disk disposed between opposing magnetic poles that generate a magnetic field, and including a coil coupled to the disk;
a weighing arm coupled to rotate with the disk, the weighing arm having first and second ends respectively extending away from the disk in opposing directions, the first end having a pan to hold material, the second end having a counterweight;
a controller circuit to apply voltage to the opposing magnetic poles to generate a magnetic field that applies torque to the disk that counters torque applied to the disk via the material in the pan; and
processing circuitry to generate an output indicative of weight of the material, based on an amount of voltage applied by the controller circuit for countering the torque applied to the disk via the material held in the pan, the controller circuit being responsive to the output by adjusting the applied voltage to actuate the weighing arm.

2. The apparatus of claim 1, further including a sensor circuit to sense the position of the weighing arm and to provide an output to the controller circuit indicative of the sensed position, wherein the controller circuit is configured to apply the voltage to the magnetic poles in response to the sensed position.

3. The apparatus of claim 2, wherein:
the galvanic actuator and weighing arm are configured to maintain the weighing arm in an unweighted position when the pan is devoid of the material; and
the controller circuit is configured to apply voltage to the magnetic poles that applies the torque to the weighing arm to position the weighing arm in the unweighted position, in response to the material being placed in the pan.

4. The apparatus of claim 1, wherein the processing circuitry is configured to output the weight of the material by correlating the amount of voltage supplied by the controller to the torque applied by the material, and by calculating the weight based on the torque and characteristics of the weighing arm.

5. The apparatus of claim 1, wherein the controller circuit is configured to, after the output indicative of the weight of the material is generated, adjust the applied voltage to cause the weighing arm to rotate for dispensing the material out of the pan.

6. The apparatus of claim 5, further including:
a sample holder to receive the material dispensed from the pan; and
an electrode to mix the powder in the sample holder.

7. The apparatus of claim 1, further including a material feed channel to dispense the material onto the pan.

8. The apparatus of claim 7, wherein the material feed channel is configured to control an amount of the material that is dispensed onto the pan based on the output indicative of the weight of the material.

9. An apparatus comprising:
a plurality of dosing stations;
a sample holder to hold a plurality of coupons, each coupon being configured to hold material, and the sample holder is further to rotate the coupons to respective ones of the dosing stations for receiving respective types of material from each dosing station;
at each dosing station, an electrobalance including:
a galvanic actuator including a disk disposed between opposing magnetic poles that generate a magnetic field, and including a coil coupled to the disk;
a weighing arm coupled to rotate with the disk, the weighing arm having first and second ends respectively extending away from the disk in opposing directions, the first end having a pan to hold material, the second end having a counterweight;
a controller circuit to apply voltage to the opposing magnetic poles to generate a magnetic field that applies torque to the disk that counters torque applied to the disk via the material in the pan, and to adjust the applied voltage to cause the weighing arm to dispense the material out of the pan and onto one of the coupons; and
processing circuitry to generate an output indicative of weight of the material, based on an amount of voltage applied by the controller circuit for countering the torque applied to the disk via the material held in the pan; and
an energy source configured to melt the material in each coupon.

10. The apparatus of claim 9, wherein the sample holder, dosing stations, electrode and energy source are configured to generate multi-layer samples having disparate compositions of material as provided by respective ones of the dosing stations by:
weighing and dispensing materials from the respective dosing stations onto the coupons to form a first layer, agitating the first layer, melting the first layer, and solidifying the first layer; and
after the first layer is solidified, weighing and dispensing materials from the respective dosing stations onto the coupons to form a second layer on the first layer, agitating the second layer, melting the second layer, and solidifying the second layer to form respective layers of material on each coupon.

11. The apparatus of claim 10, wherein for at least one of the coupons, the second layer has a composition that is different than a composition of the first layer.

12. The apparatus of claim 9, wherein at least one of the dosing stations provides a type of material for the coupons that is different than a type of material provided by another one of the dosing stations.

13. The apparatus of claim 9, further including an electrode to agitate the material in each coupon via application of electrostatic force to the material, the sample holder being configured to align each coupon to the electrode.

14. The apparatus of claim 9, further including a camera to image the coupons relative to the energy source melting material in each coupon.

15. The apparatus of claim 14, further including processing circuitry to process image data captured by the camera to assess characteristics of the material in each coupon, and to generate an output indicative of a change in processing conditions for forming the samples in each coupon, the processing conditions including conditions selected from the group of: sample composition, energy source application, and a combination thereof.

16. The apparatus of claim 15, wherein the processing circuitry is configured to utilize an AI/ML algorithm to assess the characteristics of the material and generate the output, and is configured to communicate the output to the dosing stations and the energy source for in-situ adjustment of the processing parameters.

17. The apparatus of claim 9, further including an electroplaning electrode to apply a voltage to the coupons for electrostatically mixing powder in the coupons.

18. A method comprising:
providing an electrobalance including:
a galvanic actuator including a disk disposed between opposing magnetic poles that generate a magnetic field, and including a coil coupled to the disk;
a weighing arm coupled to rotate with the disk, the weighing arm having first and second ends respectively extending away from the disk in opposing directions, the first end having a pan to hold material, the second end having a counterweight;
a controller circuit for applying a voltage to the opposing magnetic poles to generate a magnetic field that applies torque to the disk and counters torque applied to the disk via the material in the pan; and
processing circuitry to generate an output indicative of weight of the material, based on an amount of voltage applied by the controller circuit for countering the torque applied to the disk via the material held in the pan;
while feeding material into the pan, utilizing the controller circuit to adjust the applied voltage to the opposing magnetic poles to maintain the weighing arm in a fixed position; and
using the processing circuitry, generating the output indicative of the weight of the material and therein terminating the feeding of material in the pan in response to the weight achieving a target weight.

19. The method of claim 18, further including utilizing a sample holder to hold a plurality of coupons, selectively aligning each coupon with the electrobalance, and actuating the weighing arm for dispensing material from the pan into the coupon.

20. The method of claim 19, further including:
providing one of the electrobalances for each of a plurality of dosing stations;
generating multi-layer samples having disparate compositions of material as provided by respective ones of the dosing stations, by:
weighing and dispensing materials from the respective dosing stations onto the coupons to form a first layer by moving the sample holder to position the coupons relative to the dosing stations, agitating the first layer, melting the first layer, and solidifying the first layer; and
after the first layer is solidified, weighing and dispensing materials from the respective dosing stations onto the coupons to form a second layer on the first layer, agitating the second layer, melting the second layer, and solidifying the second layer to form respective layers of material on each coupon.
